(19) United States
(12) Patent Application Publication
(10) Pub. No.: US 2007/0175248 A1
(43) Pub. Date: Aug. 2, 2007

(54) Burglarproof lock for electronics devices

(75) Inventors: Chun-Sheng Wu, Chung-Ho City (TW); Chin-Yang Chien, Chung-Ho City (TW)

Correspondence Address: BIRCH STEWART KOLASCH & BIRCH, PO BOX 747, FALLS CHURCH, VA, 22040-0747, US

(73) Assignee: SINOX CO., LTD, Chung-Ho City (TW)

(21) Appl. No.: 11/649,230

(22) Filed: Jan. 4, 2007

(30) Foreign Application Priority Data
Jan. 5, 2006 (TW) 095100501

(51) Int. Cl. E05B 73/00

(52) U.S. Cl. 70/58

(57) ABSTRACT

A burglarproof lock is a lock with a connecting section and is used on electronic devices. It is used to connect and lock with the connecting port of the electronic device. The burglarproof lock includes a housing, a lock apparatus, and at least one handling device. The housing has a connecting section, and it defines a cavity where the lock apparatus is mounted inside. The lock apparatus has an axially movable shaft. The handling device is movably disposed on one side of the housing and in contact with the shaft. The handling device is movable along with a block section. One end of the block section is extended to form a clasp on one side of the connecting section. When the lock apparatus is locked, the lock apparatus will control the shaft to be unmovable. On the other hand, when the lock apparatus is unlocked, the lock apparatus release the shaft to be axially movable.

This application claims priority based on a Taiwanese patent application No. 095100501 filed on Jan. 5, 2006.

### BACKGROUND OF THE INVENTION

1. Field of the Invention

The present invention generally relates to a burglarproof lock. Particularly, the present invention relates to a burglarproof lock for preventing electronic devices from being stolen.

2. Description of the Related Art

Nowadays, consumer electronic products such as mobile phone, MP3 player, digital camera and handheld game console, are widely used. In an already challenging and dynamic market, along with the technological development in the electronic devices, the designs of consumer electronic products today provide not only the versatility in functions but also the convenience in operation. Therefore, consumer electronic devices today are designed to provide an easy-to-carry characteristic so that consumers can use them everywhere at any time. Furthermore, in order to enhance the convenience in the usage, consumer electronic devices are often designed to be thin in the size and light in the weight. Due to the advanced qualities mentioned above, consumers electronic devices are frequently used at home as well as outside in publics. However, since the values of many consumer electronic devices tend to be high while they are “easy-to carry”, they have a higher likelihood to be stolen. Therefore, many burglarproof locks for consumer electronic devices have been developed to prevent devices from being stolen.

For example, Taiwanese Patent No. M247667 and U.S. Pat. No. 6,796,152B1 disclose a combination lock which comprises a bolt member for portable computers. The purpose of the complex bolt is to connect with the connecting port of the computer, and the combination lock controls the complex bolt to be locked or unlocked with the computer's port. However, the traditional methods which above patents use are more time-consuming and troublesome compared to the present invention.

Moreover, the commonly used connectors have no burglarproof function such as locks or chains. Therefore, not only the valuable electronic devices can be stolen, the confidential data stored in the devices may also be read or used without the consent of the rightful possessors.

### SUMMARY OF THE INVENTION

It is a primary object of the present invention to provide a burglarproof lock for electronic devices that prevent the devices from being stolen.

It is another object of the present invention to provide a connector with burglarproof feature.

It is another object of the present invention to provide a burglarproof lock with a cord that can be coiled around an article to attach the lock to the article.

It is another object of the present invention to provide a burglarproof lock or connector that is handy in operating and quick in connecting and disconnecting.

The present invention of the burglarproof lock is used on an electronic device for connecting with the connecting port of the electronic device, and the burglarproof lock includes a housing defining a cavity, a lock apparatus mounting in the cavity and at least one handling device. The housing has a connecting section extending from one side of the housing. The lock apparatus is mounted in the cavity defined by the housing and has at least one axially movable shaft. The handling device is disposed on one side of the housing. It is in contact with the shaft and sidelong movable along with the axially movable shaft. Furthermore, the handling device is movable along with a block section. One end of the block section is extended to form a clasp on one side of the connecting section. When the lock apparatus is locked, the lock apparatus will restrict the shaft and the handling device to be unmovable. On the other hand, when the lock apparatus is unlocked, the lock apparatus release the shaft and the handling device from the restriction of the movement.

### BRIEF DESCRIPTION OF THE DRAWINGS

FIG. 1 shows an exemplary embodiment of the present invention which connects with an electronic device.

FIG. 2 is a decomposition view of an embodiment of the present invention.

FIG. 3 is a sectional lateral view of an embodiment of the present invention.

FIG. 4 is a cross-sectional view of an embodiment of the present invention.

FIG. 5 shows a first motion of a burglarproof lock in unlocked status shown in FIG. 4.

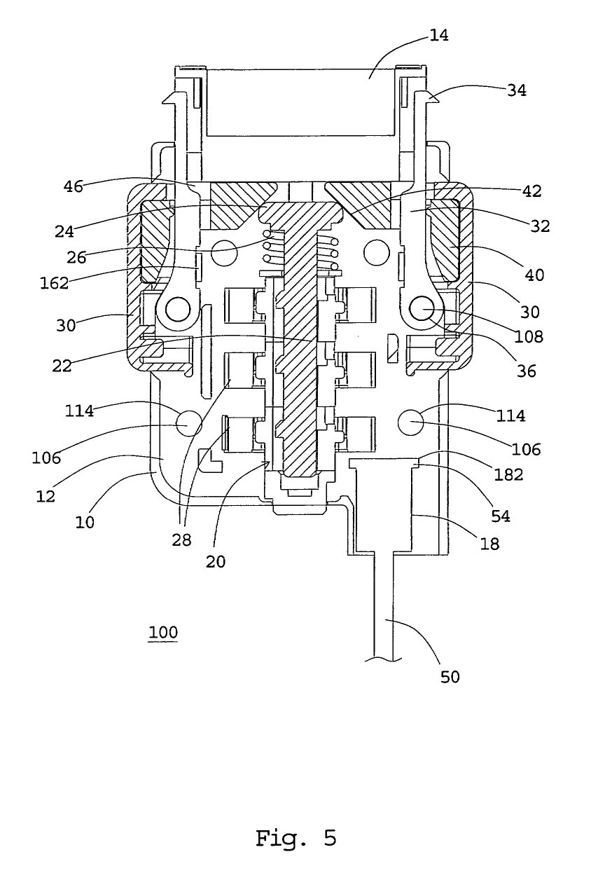

FIG. 6 shows a second motion of a burglarproof lock in unlocked status shown in FIG. 4.

FIG. 7 shows an embodiment of the present invention in the operating status.

### DETAILED DESCRIPTION OF THE PREFERRED EMBODIMENT

The preferred embodiments of the present invention are illustrated hereunder with the attached drawings.

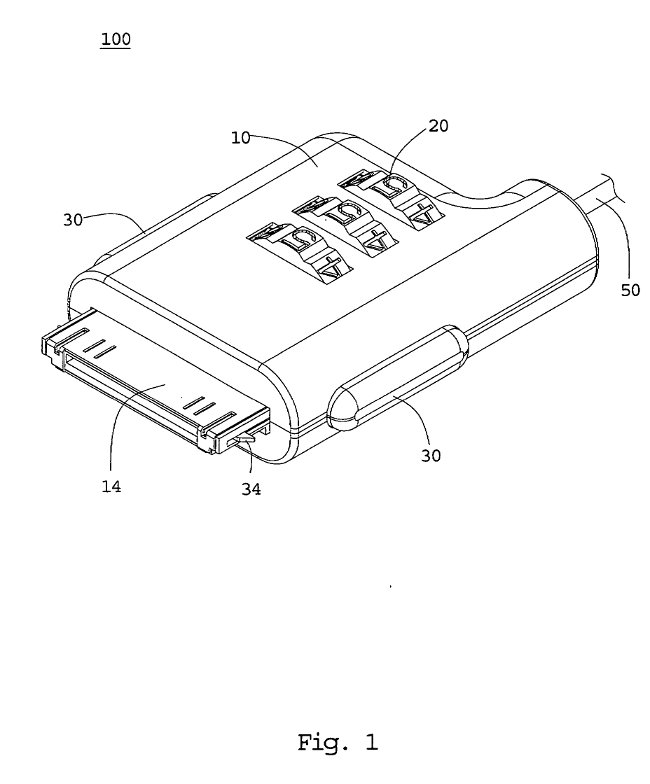

Please refer to FIG. 1, the burglarproof lock 100 of the present invention is provided to connect with the connecting port 202 of the electronic device 200. The electronic device 200 may be a MP3 player, a mobile phone, a Personal Digital Assistant (PDA), a laptop or any other consumer electronic product having a connecting port/socket.

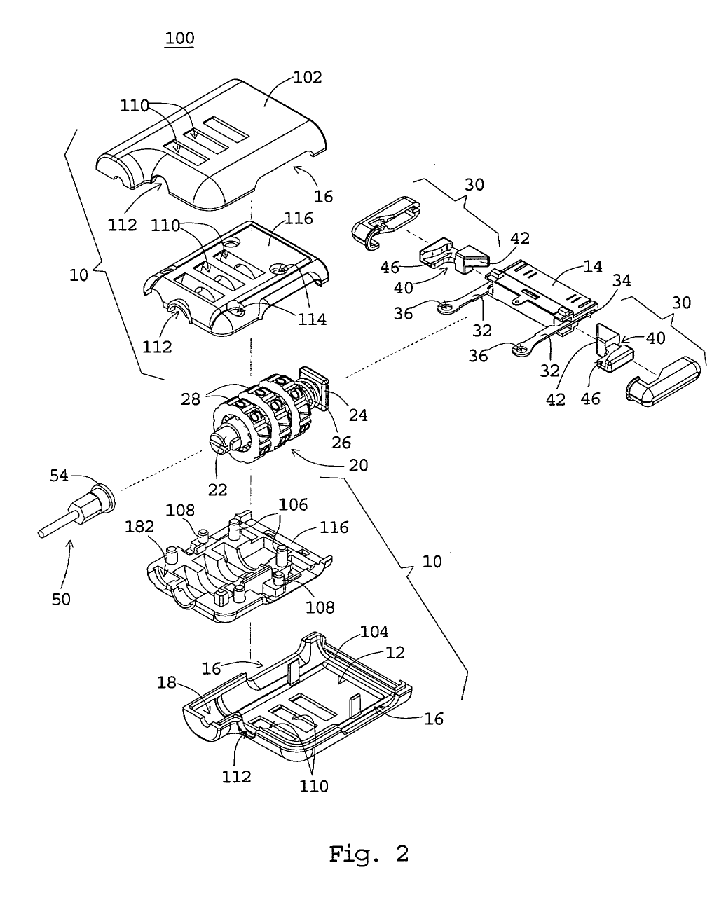

Please further refer to FIG. 2, the burglarproof lock 100 comprises a housing 10 a lock apparatus 20 and at least one handling device 30. The housing 10 preferably includes a connecting section 14 and an inner cavity 12, wherein the housing 10 defines at least one chamber 16 and a room 18. The connecting section 14 is disposed on one end of the housing 10. It is preferably a plug or any component that can connect with or insert into a connecting port 202 of an electronic device 200. The lock apparatus 20 is preferably disposed in the inner cavity 12, and the handling device 30 is mounted in the chamber 16. In the embodiment of the present invention which FIG. 2 shows, the present invention preferably has a pair of handling devices 30; therefore, it is preferable that the housing 10 contains two chambers 16. The room 18 is provided to assemble with a flexible cord 50. Within the room 18, the flange 54 of the flexible cord 50 is disposed attaching to the fillister 182 for engaging the flexible cord 50 into the housing 10.

The housing 10 preferably includes a first half housing 102, a second half housing 104 and two pieces of corresponding rubber molding 116 disposed between the first and the second half housing when the present invention is fully assembled. The first rubber molding 116 on the first half housing 102's side has a plurality of holes 114 and a plurality of rectangular holes 110. The second rubber molding 116 on the second half housing 104's side has a plurality of pillars 106 and a plurality of rectangular holes 110 that correspond to the rectangular holes 110 on the first half housing 102. The above mentioned pillars 106 are provided to be inserted into holes 114 for assembly and the above mentioned rectangular holes 110 are provided to position the wheels 28 of the lock apparatus 20. In this embodiment, the lock apparatus 20 is preferably a combination lock with multiple numeral wheels 28. The above mentioned pillars 106 further includes at least one positioning pillar 108, and in the preferred embodiment, it is the best to include two positioning pillars 108. The rubber molding 116 can be made of rubber, plastic or other ductile materials. However, in the other embodiment, the first half housing 102 and the second half housing 104 can be assembled without the rubber molding 116 inside.

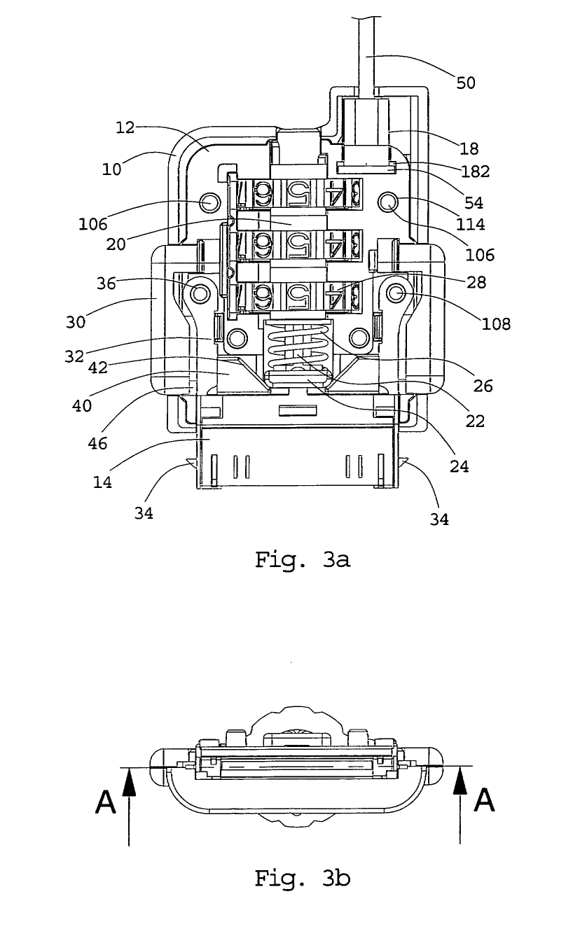

In the embodiment which FIG. 3 shows, the lock apparatus is preferably a combination lock comprising multiple numeral wheels 28, wherein an axially movable shaft 22 is disposed inside the multiple numeral wheels 28. When all the numeral wheels 28 are turned to the predetermined code, aligning each code number to the corresponding notch, the lock apparatus 20 releases the shaft 22 to be axially movable. A flat plate 24 is formed on one end of the shaft 22, and a flexible member 26 is disposed between the lock apparatus 20 and the flat plate 24. The handling device 30 is disposed on one side of the housing 10, and it is in contact with the shaft 22. Furthermore, the sidelong movement of the handling device 30 will trigger the shaft 22 to move axially. In this embodiment, the handling device 30 is preferably in contact with the flat plate 24 of the shaft 22, and the flexible member 26 is preferably a spring or other flexible element. However, in a modified embodiment, the handling device 30 can be movable in a different direction to trigger the movement of the shaft 22.

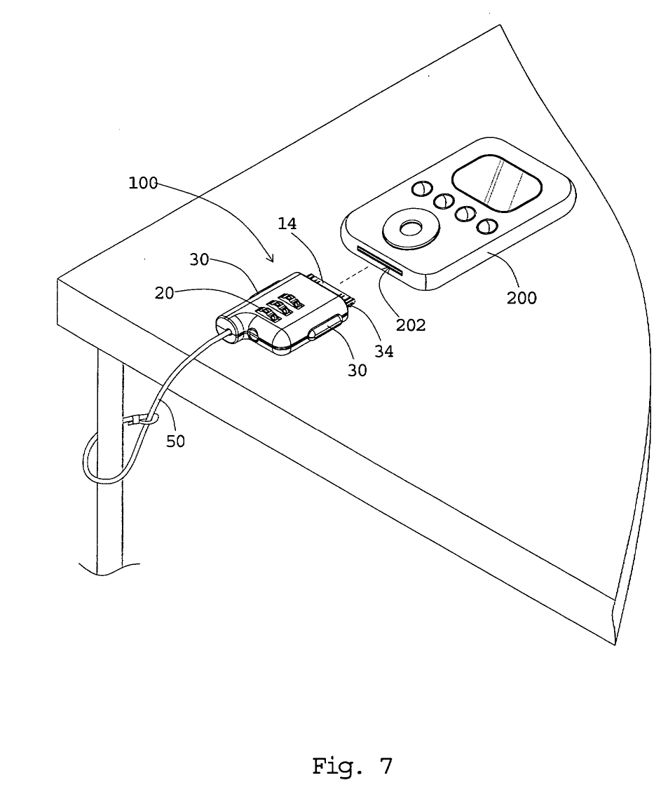

The handling device is movable along with a block section 32. One end of the block section 32 extends to forms a clasp 34 on one side of the connecting section 14. Please refer to the embodiment of FIG. 7, the clasp 34 is provided for engaging with the connecting port 202 of the electronic device 200 (not illustrated in FIG. 7). When the lock apparatus 20 is locked, the lock apparatus 20 will control the shaft 22 and handling device 30 to be unmovable. On the other hand, when the lock apparatus 20 is unlocked, the lock apparatus 20 release the shaft 22 and the handling device 30 from the restriction of movement.

The handling device 30 preferably includes an auxiliary element 40, wherein the auxiliary element 40 has a guiding surface 42 and a breach 46. The guiding surface 42 is formed on one end of the auxiliary element 40 and in contact with the flat plate 24 of the shaft 22. The breach 46 of the auxiliary element 40 is provided to fasten the sheet-formed block section 32. One end of the block section 32 has an assembly hole 36 provided for inserting the positioning pillar 108. As a result, the other end of the block section 32 can move relative to the positioning pillar 108. In this embodiment, the guiding surface 42 is preferably an inclined surface that can slide against the flat plate 24, and the auxiliary element 40 and block section 32 are preferably in pairs.

When the lock apparatus 20 is locked, the lock apparatus 20 restricts the shaft 22 from movement; in other words, the shaft 22 is unable to be axially movable. Because the flat plate 24 of the shaft 22 is in contact with the guiding surface 42, the handling device 30 is unable to control the auxiliary element 40 to move in sidelong direction. If the connecting section 14 is further connected to the connecting port 202 of the electronic device 200 and the clasp 34 is engaged with the connecting port 202, since the auxiliary element 40 cannot be moved, the clasp 34 cannot be disengaged from the connecting port 202 by operating the handling device 30. As a result, the burglarproof lock 100 successfully locks the electronic device to the article, which prevents the device from being stolen (please also refer to FIG. 1).

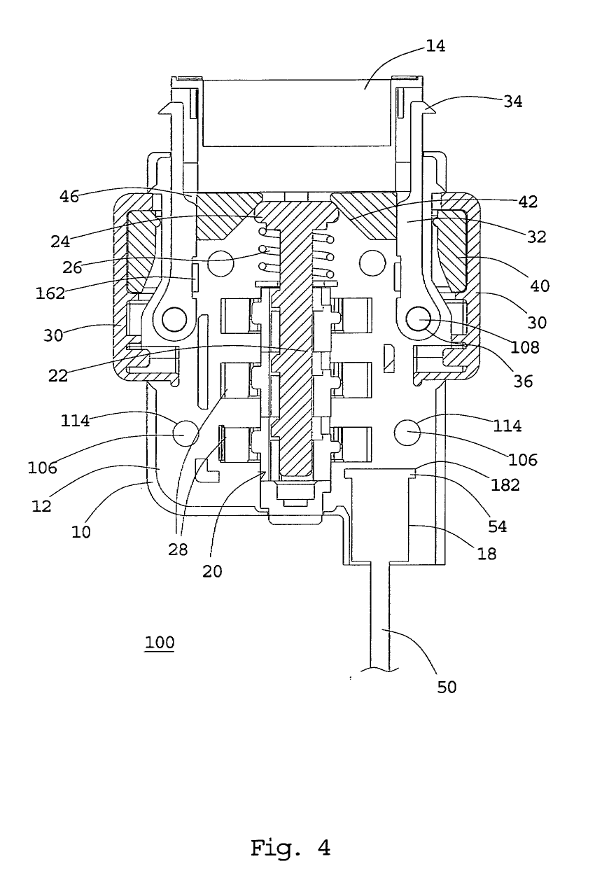

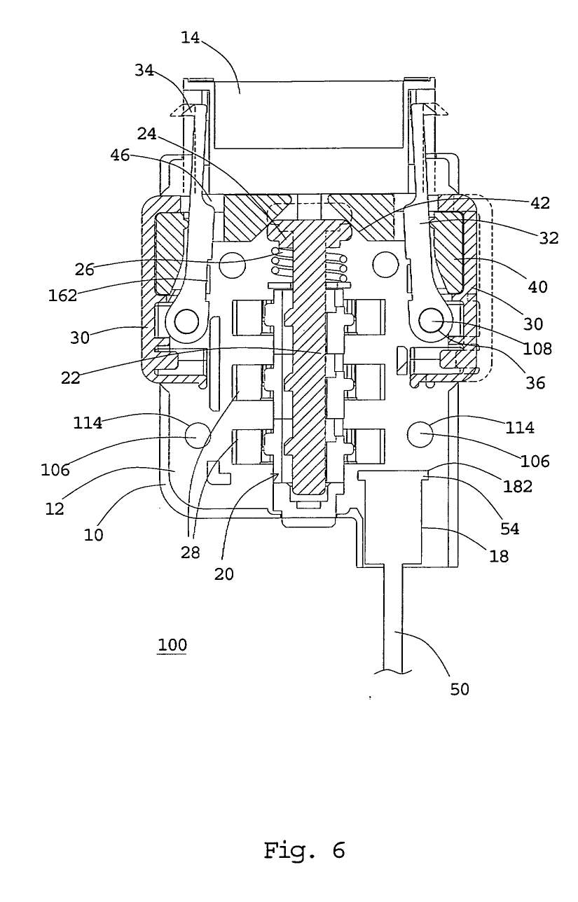

The movement of the present invention are analyzed in FIG. 4˜FIG. 6 and accompanying the following description. When the lock apparatus 20 is unlocked, the shaft 22 and the handling device 30 are released from the restriction of the lock apparatus 20 and become movable.

When a user temporarily leaves his or her electronic device without locking to a burglarproof lock, the device as well as the valuable data inside has a high likelihood to be stolen. Therefore, the present invention includes not only a connecting section 14 to lock with the connecting port 202 of the electronic device 200 but also a flexible cord 50 which can be coiled to an article such as a desk. In the embodiment which FIG. 7 shows, the flexible cord 50 of the burglarproof lock 100 is coiled to a leg of a desk. However, in a different embodiment, the flexible cord can be coiled to any article, such as a backpack or a bicycle. In this embodiment, the flexible cord 50 is preferably made of steel or a chain that is difficult to be cut off. Regarding how the flexible cord 50 is coiled to an article, it pertains to prior art and will not be further described hereafter.

The burglarproof lock 100 of the present invention can be otherwise viewed as a connector with a burglarproof lock. Because the burglarproof lock/connector can be disconnected quickly and the handling device 30 can return to the original position automatically, the present invention is handy and practically useable.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claimed:

1. A burglarproof lock for an electronic device, the burglarproof lock being connectable with a connecting port of said electronic device, comprising:
a housing with a connecting section, one end of said housing is formed with said connecting section in which said connecting port can be connected;
at least one handling device is movably mounting in one side of the housing, said handling device is movable in combination with a block section, said block section is disposed by one side of said connecting section; and
a lock apparatus is disposed on said housing;
wherein when said lock apparatus is locked, said lock apparatus restricts said handling device from movement, and when said lock apparatus is unlocked, said lock apparatus releases said handling device to be movable.

2. The burglarproof lock as claimed in claim 1, wherein said lock apparatus has multiple numeral wheels and an axially movable shaft fitted in said numeral wheels, whereby when all said numeral wheels are turned to the set numbers and said lock apparatus is unlocked, said lock apparatus releases said shaft to be axially movable.

3. The burglarproof lock as claimed in claim 2, wherein said handling device is movably mounted in one side of said housing, said handing device is in contact with said shaft, whereby said handling device is movable along with said shaft axially moved.

4. The burglarproof lock as claimed in claim 2, wherein said handling device is sidelong movably mounted in one side of said housing, whereby said handling device is sidelong movable along with said shaft axially moved.

5. The burglarproof lock as claimed in claim 2, wherein one end of said shaft is formed with a flat plate, the head end of said flat plate is in contact with said handling device.

6. The burglarproof lock as claimed in claim 5, wherein the burglarproof lock further comprises a flexible member disposed between said lock apparatus and said flat plate.

7. The burglarproof lock as claimed in claim 1, wherein one end of said block section is formed with a clasp for engaging with said connecting port.

8. The burglarproof lock as claimed in claim 1, wherein the burglarproof lock further comprises a flexible cord, and said housing further comprises:
an inner cavity for mounting said lock apparatus;
at least one chamber for mounting said handling device; and
a room for mounting said flexible cord.

9. The burglarproof lock as claimed in claim 7, wherein said room further comprises a recess, one end of said flexible cord is formed with a flange disposed opposite to said recess.

10. The burglarproof lock as claimed in claim 1, wherein said housing further comprises:
a first half-housing with a plurality of assembly holes; and
a second half-housing disposed opposition to said first half-housing, said second half-housing having a plurality of pillars for inserting into said assembly holes, said pillars including at least one positioning pillar.

11. The burglarproof lock as claimed in claim 10, wherein one end of said block section further includes an assembly hole for said positioning pillar to insert into.

12. The burglarproof lock as claimed in claim 1, wherein said handling device further comprises an auxiliary element, one end of said auxiliary element is formed with a guiding surface, said guiding surface is in contact with the head end of said shaft.

13. The burglarproof lock as claimed in claim 12, wherein said auxiliary element further includes a breach for positioning said block section.

14. The burglarproof lock as claimed in claim 1, wherein said lock apparatus includes a combination lock.

15. A connector is provided with a burglarproof lock, the connector including:
a housing with a connecting section, one end of said housing is formed with said connecting section;
at least one handling device is movably mounting in one side of said housing, said handling device is movable in combination with a block section, said block section is disposed by one side of said connecting section; and
a lock apparatus is disposed on said housing;
wherein when said lock apparatus is locked, said lock apparatus restrict said handling device from movement, when said lock apparatus is unlocked, said lock apparatus releases said handling device to be movable.

16. The connector as claimed in claim 15, wherein said lock apparatus includes multiple numeral wheels and an axially movable shaft fitted in said numeral wheels, whereby when all the said numeral wheels are turned to the set numbers and said lock apparatus is unlocked, said lock apparatus releases said shaft to be axially movable.

17. The connector as claimed in claim 16, wherein said handling device is movably mounted in one side of said housing, said handling device is in contact with said shaft, whereby said handling device is movable along with said shaft axially moved.

18. The connector as claimed in claim 16, wherein said handling device is sidelong movably mounted in one side of said housing, whereby said handling device is sidelong movable along with said shaft axially moved.

19. The connector as claimed in claim 16, wherein one end of said shaft is formed with a flat plate, the head end of said flat plate is in contact with said handling device.

20. The connector as claimed in claim 19, wherein the burglarproof lock further comprises a flexible member disposed between said lock apparatus and said flat plate.

21. The connector as claimed in claim 15, wherein one end of said block section is formed with a clasp.

22. The connector as claimed in claim 15, wherein said connector further includes a flexible cord, wherein said housing comprising:
an inner cavity for mounting said lock apparatus;
at least one chamber for mounting said handling device; and
at least one room for mounting said flexible cord.

23. The connector as claimed in claim 22, wherein said room further comprises a recess, one end of said flexible cord further includes a flange disposed opposite to said recess.

24. The connector as claimed in claim 15, wherein said housing further comprises:
a first half-housing with a plurality of assembly holes; and
a second half-housing disposed opposition to said first half-housing, said second half-housing having a plurality of pillars for inserting into said assembly holes, said pillars including at least one positioning pillar.

25. The connector as claimed in claim 24, wherein one end of said block section further includes an assembly hole for said positioning pillar to insert into.

26. The connector as claimed in claim 15, wherein said handling device further includes an auxiliary element, one end of said auxiliary element is formed with a guiding surface, said guiding surface is in contact with the head end of said shaft.

27. The connector as claimed in claim 26, wherein said auxiliary element further includes a breach for positioning said block section.

28. The connector as claimed in claim 15, wherein said lock apparatus further comprises a combination lock.
